(19) United States
(12) Patent Application Publication
(10) Pub. No.: US 2018/0106748 A1
(43) Pub. Date: Apr. 19, 2018

(54) Protective coating for a potentiometric electrode assembly

(71) Applicant: Sartorius Stedim Biotech GmbH, Göttingen (DE)

(72) Inventors: Christian Grimm, Heilbad Heiligenstadt (DE); Henry Weichert, Westewitz (DE); Julia Lueders, Göttingen (DE)

(21) Appl. No.: 15/568,850

(22) PCT Filed: Apr. 25, 2016
(86) PCT No.: PCT/EP2016/000654

§ 371 Date: Oct. 24, 2017

(30) Foreign Application Priority Data
Apr. 29, 2015 (DE) 10 2015 005 472.4

(51) Int. Cl. G01N 27/30; G01N 27/36; G01N 27/403

(52) U.S. Cl. CPC G01N 27/302; G01N 27/4035; G01N 27/36

(57) ABSTRACT

There is provided a potentiometric electrode assembly comprising an ion-selective electrode, a reference electrode and a reference electrode electrolyte, the reference electrode having a diaphragm or an open-junction opening or a combination thereof which is provided with a protective coating detachable and/or dissolvable upon contact with aqueous solution.

The invention relates to a potentiometric electrode assembly, preferably for single use, the diaphragm or an open-junction opening of the reference electrode in relation to the material to be measured being provided with a protective coating (hereinafter also called sealing layer) which prevents substances from escaping or crystallizing when the electrode assembly is sterilized and is stored in a dry state for a relatively long time.

The determination of pH, i.e., the determination of the hydrogen ion concentration as negative logarithm, is an established method for, for example, monitoring the environment of a biochemical reaction in a culture liquid. Potentiometric determination is outstandingly suitable for this purpose owing to the robustness of the measurement method and the equipment. In potentiometric determination, the potential formed between measurement electrode and a further electrode, called reference electrode owing to its constant potential, is measured in the absence of current. Both electrodes form a so-called potentiometric electrode assembly. The best-known measurement electrode for determining pH is the glass electrode.

US 2014/0299471 describes a pH sensor having a measurement electrode composed of metal coated with Nafion.

US 2010/0025235 describes a glass electrode having a titanium dioxide layer.

U.S. Pat. No. 3,591,482 A discloses chloride-ion-sensitive devices in which the silver chloride layer of an Ag/AgCl electrode is coated with a thin methacrylate protective layer.

As already stressed, the measurement of pH is one of the essential necessary tasks in a cell culture process or fermentation process. In the majority of commercial productive upstream processes, pH is checked within the culture. To this end, an in situ/inline measurement of pH is necessary. The means of measurement that are used in conventional stainless-steel bioreactors are usually classic, electrochemical measurement probes. These are, for example, introduced into the reaction vessel via a PG13.5 screw fitting or an Ingold 25 mm port. These probes are usually distinguished by the following basic elements:
Measurement electrode containing electrolyte
Reference electrode containing electrolyte
Diaphragm or open junction
Integrated temperature sensor (PT100/1000) for temperature correction

In this connection, the electrolyte used can be liquid, gelatinous or solid and is in many cases based on KCl solutions or other salt solutions. When used, the electrode is, prior to use, either autoclaved with the reaction vessel or sterilized directly in the reactor by steam sterilization, depending on the size of the bioreactor made of stainless steel. To this end, the pH electrode, which is usually stored in a solution composed of 3 M KCl solution, is removed from the storage liquid, cleaned (generally with WFI—water for injection), and inserted into the reaction vessel.

There is now a stronger trend in the biopharmaceutical industry toward so-called single-use bioreactors, such as, for example, bags composed of plastics film. Here too, it is self-evident that pH is checked. To this end, it is also possible to insert into such bioreactors an electrochemical pH probe designed for single use in single-use plastics bioreactors. These pH electrodes are distinguished by the fact that they are storable in a dry state, i.e., probe tip and diaphragm are dried out and can be stored in the bag with exposure to air for several months, for example in a welded-in port. This means that the electrode assembly is, as a result of welding, adhesive bonding or the like, permanently or integrally connected to the bag and thereby connected thereto such that detachment is not possible unless destruction is effected.

The generally customary method for sterilizing bags is irradiation with, according to regulatory requirements, at least 25 kGy, in extreme cases up to 50 kGy, gamma radiation. As a result of the irradiation and over the course of the dry storage in the bag, an outflow of electrolyte across the diaphragm or the open junction may occur over time. This leads to either drops or crystals of the electrolyte collecting and being visible at the probe tip or even in the bag. However, an essential quality feature for bags is that they are free of any visible particles or contaminants prior to use. It is self-evident that these contaminants may no longer be removed from the sterilized bag prior to the use of the single-use bioreactor. Even if the particles or drops arising because of the escaping electrolyte do not affect the culture and the process, this is an undesired side effect. An increased escape of KCl can have considerable effects on the culture, especially in the case of small-volume bags. This is undesired from the customer's side.

It is therefore an object of the present invention to prevent or to at least greatly minimize the escape of reference electrode electrolyte, so that no contaminants in the form of crystals from the conducting salt of the reference electrode liquid or droplets of the reference electrode liquid reach the material to be measured.

This object is achieved by a potentiometric electrode assembly comprising an ion-selective electrode, a reference electrode and a reference electrode electrolyte, the reference electrode having a diaphragm or an open-junction opening or a combination thereof, at least the diaphragm or the open-junction opening being provided with a protective coating detachable and/or dissolvable in aqueous solution. However, it is also possible for the entire probe tip to be covered.

In other words, the present invention is based on a sealing of the diaphragm or the open-junction opening of a single-use pH electrode inserted integrally into a bioreactor by means of a detachable and/or dissolvable protective coating, the result of this being that, surprisingly, the hitherto observed crystal formation or droplet formation, which represents a safety and quality defect, fails to materialize and the measurement system can be used as intended despite the sealing, even if the entire bioreactor has been sterilized beforehand, for example by gamma irradiation.

Advantageous further developments and designs of the invention are specified in the dependent claims and the additional independent claims.

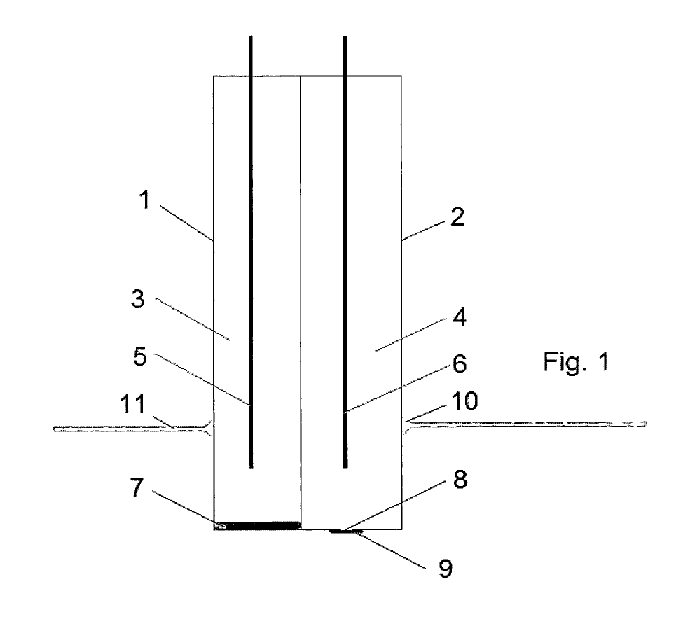

The invention will be described below on the basis of detailed exemplary embodiments with reference to the attached drawing (FIG. 1).

FIG. 1 shows a potentiometric electrode assembly (electrodes 1 and 2) provided with the detachable and/or dissolvable protective coating 9 used according to the invention, the junction from the reference electrode space 2 to the space of the material to be measured being effected by means of a tiny opening (open-junction opening) 8. Instead of the tiny opening 8, it is also possible to use a diaphragm.

The glass electrode is highly specific for hydrogen ions or hydronium ions H₃O⁺, in other words, it is ion-selective with regard to these ions. The electrochemical potential of the glass membrane changes depending on the activity of the hydrogen ions in the measurement solution, the material to be measured. The glass membrane of the pH electrode assemblies is the most frequently used electrochemical sensor. An ion-selective glass membrane can be considered as a solid-state electrolyte: ion-exchange and ion-transfer processes are responsible for the formation of potential. Hydronium ions or hydroxyl ions are deposited on this membrane and shift the potential of the electrode assembly in an activity-dependent manner. This means that, in the case of an ion-selective measurement electrode, the activity of an ion species is captured, H₃O⁺ (or OH⁻) in the case of the glass electrode, there being a multiplicity of other ion-selective measurement electrodes which can be used for cations, for example Na⁺, K⁺, Ag⁺, NH₄⁺, Cd²⁺, Cu²⁺, Pb²⁺, Ca²⁺ or the like, or anions, for example Br, Cr, F, NO₃⁻ or S²⁻ or the like, for specific measurement. The ion-selective membranes are largely closed for mass transport. This means that, from a glass electrode, there are substantially no substances, for example from the electrode filling, from the measurement electrode electrolyte, passing over into the material to be measured.

The ion-selective electrodes are connected to a reference electrode via a reference electrode electrolyte, a diaphragm, and the material to be measured. In contrast to the measurement electrode, there is in the case of the reference electrode with its diaphragm or with the open-junction opening, however, the possibility of mass transport, albeit low mass transport, from the reference electrode liquid to the exterior of the reference electrode when said reference electrode is facing the air. In this connection, there might be the possibility of the formation of crystals from the salt of the reference electrode electrolyte or of concentrated droplets of the reference electrode liquid, which adhere to the diaphragm or fall into the bag of the single-use bioreactor and soil said bioreactor. Especially in the case of relatively small bioreactors, it is undesirable for salt quantities from reference electrode electrolytes to pollute the liquid material to be measured when, for example, a bag reactor is filled with culture liquid.

So-called combination electrodes containing a measurement electrode have been found to be effective in practice, consisting of the measurement membrane (in the case of the glass electrode, a thin glass membrane) and a reference electrode (in most cases, an Ag/AgCl electrode), often additionally combined with a temperature sensor, with all components being arranged in one housing and only the measurement electrode surface and the diaphragm connected to the reference electrode or an open-junction opening being exposed.

The reference electrode electrolyte should have a small electrical resistance; it must not react with the measurement solution or soil said solution. The reference electrode electrolyte in the Ag/AgCl reference electrode is in many cases a 3 M KCl solution. Measurement electrode and reference electrode are physically separated from one another and only the measurement membrane of the measurement electrode and the reference electrode electrolyte of the chamber of the reference electrode are in contact with the material to be measured. In this connection, care must be taken that no reference electrode electrolyte or only very little leaves the chamber of the reference electrode. This is achieved by a highly ion-conductive closure with a diaphragm (e.g., a glass frit or a porous ceramic) or by a tiny hole in the housing of the reference electrode—a so-called open-junction opening—so that in principle there is only ion conduction between reference electrode space and measurement space containing the material to be measured. The diaphragm can be a porous partition wall. Consequently, the purpose of the diaphragm is to separate the reference electrode electrolyte from the sample solution and to prevent mixing—at the same time, the diaphragm must ensure the electrical connection of the two half cells (measurement electrode and reference electrode). There are various customary configurations: (plastics) fiber diaphragm, platinum diaphragm, ground-joint diaphragm, ceramic diaphragm, etc. The measurement voltage, i.e., the potential, appearing between measurement electrode and reference electrode across the membrane or the open-junction opening is then the actual measurement signal.

According to the invention, after the pH electrode has been produced and its calibration parameters or similar quality values have been captured, the diaphragm is temporarily closed by application of a sealing layer. The application can be effected either by dripping, spreading, sputtering, vapor deposition, adhesive bonding, pressing, etc. with a substance present in a solution, melt, film or solid. The substance to be used for this purpose should preferably meet the following minimum requirements:
water solubility, and
not inhibit cell growth and/or
be a material authorized for pharmaceutical manufacturing processes (e.g., Ph. Eur., USP, FDA)

Possible substances include the following substance groups:
substances that are present in the culture anyway, such as nutrients, for example: glucose or other sugars
biological polymers degradable in water, for example polymerized starch, polyvinyl alcohols,
excipients from medicaments, such as, for example, microcrystalline cellulose (MCC).

After application and, if necessary, drying, the sealing layer composed of the selected substances is stable to the extent that, although possibly water can be transported through the layer, for example by diffusion, apparently no salts are transported in a quality-reducing amount. Surprisingly, after sterilization by gamma irradiation, no crystallization of electrolyte or droplet formation was observed even in the case of relatively long storage.

If, after storage, the bag is then filled with medium or buffer, the applied layer dissolves in the medium within a few minutes and the diaphragm or the like is again free for measurement. This only minimally affects the natural swelling time of the glass tip and of the diaphragm and thus the time until operational capability. This also avoids the use of a mechanical protection of the diaphragm by insertion into a compartment or the like.

In addition to the Ag/AgCl electrode already mentioned, what can be named as reference electrodes used in the invention are the standard hydrogen electrode, the saturated calomel electrode, the Cu/CuSO₄ electrode or the Hg/Hg₂SO₄ electrode, though preference is given to the Ag/AgCl electrode owing to its simplicity and stability. By using appropriate diffusion routes, the reference electrolyte can be kept virtually silver-free.

Within the present invention, single use means that the potentiometric electrode assembly is used only once and then disposed of as a component of a device, for example of a single-use bioreactor, individually or with the entire device.

A material to be measured in the context of the present invention is an aqueous solution (aqueous solution refers to all liquid mixtures containing at least 50% water), for example the contents of a biochemical reactor or fermenter, for example a culture solution.

Salts which can be used as reference electrode electrolyte are especially alkali metal halides, for example sodium chloride, lithium chloride, sodium bromide, potassium bromide, ammonium chloride, but especially potassium chloride.

Detachable in the context of the present invention means that the protective coating used according to the invention lifts and detaches from the diaphragm upon contact (i.e., immediately) or after relatively short contact (e.g., from 1 s to 1 min or from 5 s to 2 min or from 10 s to 5 min) with the material to be measured, for example initially as a result of swelling and then as a result of mechanical tension owing to the length change of the substrate, with the detached material dissolving slowly, but not in an interfering manner, in the material to be measured.

A protective coating in the context of the present invention is a cover of any kind over the diaphragm or the open-junction opening, having a thickness allowing detachment or dissolution of the cover or the protective coating within a reasonable time. The thickness of the protective coating depends on the mechanical stability of the material and on the detachment or dissolution rate of the protective-coating material.

The protective coating provided according to the invention is detachable and/or dissolvable upon contact with an aqueous solution and then allows ionic access to the diaphragm or to the open-junction opening. In front thereof, it serves as a barrier for the electrolyte of the reference electrode during storage in order to prevent in particular crystal or drop formation. In contrast, the protective coating in U.S. Pat. No. 3,591,482 A, as cited at the start, has a different task, i.e., it is intended to prevent in the measurement solution, for example, the Ag reference electrode from aging and nevertheless retaining chloride-ion sensitivity. Thus, it must not detach or dissolve upon contact with the measurement solution in order to perform this task.

A material authorized for pharmaceutical manufacturing processes preferably meets the requirements specified in the German Arzneimittelgesetz [medicinal products act]. In particular, this quality feature means that there is no addition, as a result of the detachment or dissolution processes, to the material to be measured of substances which might impair the quality of a biochemical product produced in this way. For example, the products produced from the material to be measured must not contain any detached or dissolved constituents which would not be removable during cleanup according to the principles of good manufacturing practice or, if not completely removable, would impair the intended pharmaceutical quality or chemical purity of the product.

Substances which come into contact with culture liquid and must not inhibit cell growth can be checked prior to use. For instance, cells can be contacted with the materials of the protective-coating material to be used according to the invention and their growth behavior tested.

A culture liquid is generally identical to the contents of a biochemical or biotechnological reactor. It contains all the nutrients and auxiliary substances required for the growth of microorganisms. Substances usually present in a culture liquid are nutrients containing the main nutritional elements, for example carbon, nitrogen and phosphorus. Furthermore, nutrients are required which, depending on the microorganism, provide trace elements, for example manganese, zinc, copper, cobalt, etc. Furthermore, depending on the microorganism, nutrients are required which contain molecules which cannot be synthesized by the microorganisms or other cells themselves and must therefore be fed externally, such as essential amino acids, fatty acids, or monosaccharides or oligosaccharides. Also important are minerals which contain alkali metal ions (including ammonium ions), alkaline earth metal ions, iron ions and biochemically relevant anions, such as halides, nitrate, sulfate, phosphates, silicates, hydroxide or oxides.

Polymers degradable in aqueous solution are especially polymers which dissolve in aqueous solution at a defined rate. These include monosaccharides, disaccharides and oligosaccharides, such as glucose, maltose, lactose, maltodextrins, sugar alcohols, etc., polysaccharides, such as low-molecular-weight starches, soluble starch and other starch derivatives, or cellulose derivatives, polyvinyl alcohol, polylactates, polyacrylic acid derivatives, polyethylene glycols, etc., and biochemically and pharmaceutically neutral peptides and proteins, such as albumin. Furthermore, these include substances which swell and then detach, such as swellable gums, for example xanthan gum derivatives, superabsorbent polymers, Cellophane, polyvinylpyrrolidone or the like.

Excipients for medicaments that are usable in the present invention are, for example, microcrystalline cellulose, HPMC, HEC, CMC, povidone or the like.

Dry in the context of the present invention means that the protective-coating material used according to the invention and applied in aqueous solution forms, after the action of heat, for example hot air, a solid or a solid film which no longer allows reference electrode electrolyte to escape from the space of the reference electrode and to form a contamination there, such as salt crystals or droplets.

The single-use electrode assemblies can be mounted in a precalibrated state. A calibration is necessary in order to determine and to mathematically compensate for deviations of the actual electrode from the ideal behavior with regard to the zero point and the slope of the electrode. The process in pH measurement that is referred to as calibration is actually an adjustment. To this end, use is made of standard solutions of defined pH. The zero point of the electrodes is nowadays normally a pH of 7.00. The slope of the relevant electrode is determined on the basis of further buffer solutions (usually pH=4.00 and pH=10.00) and adopted by the measurement device for later experiment evaluation. Precalibrated and dry glass electrodes require, however, a certain period of time until a constant measurement appears.

In connection with this invention, biochemical reaction refers to any form of conversion of substances via biochemical processes. Such a conversion includes the cultivation of cells, of microorganisms including viruses, the expression of proteins from host microorganisms, enzymatic reactions, biochemical polymerization processes, etc.

Solutions are homogeneous mixtures of two or more substances. Usually, one substance (solvent) is present in a large excess. The dissolved substance is present in the form of molecules or ions. In the case of an electrochemical measurement, such as potentiometry, aqueous solutions are usually considered. Solutions in the context of the present invention are, however, also colloidal solutions and other fine dispersions or suspensions of substances that are in accordance with the intended use, i.e., they, for example, do not interfere with the course of the biochemical reaction or impair the intended chemical or pharmaceutical quality of the target product.

The following examples elucidate the present invention. All percentages are based on weight, unless otherwise stated.

### EXAMPLES

### Example 1

A single-use pH combination electrode is provided with a protective coating over the diaphragm/open junction by application of a concentrated hydroxypropylmethylcellulose solution composed of 5% Metolose (manufacturer: Harke Pharma), 45% ethanol and 50% water, and this film is left to dry in the air.

For the preparation of the solution, ethanol was used as dispersant in order to achieve a good distribution of the pulverulent raw material before the water was added and in order to quicken the subsequent drying of the applied solution.

The electrode assembly is stored in a laboratory drying cabinet at 50° C. for 28 days. Crystals or droplets originating from the reference electrode liquid were not observed after passing of the storage time.

The swelling time of the electrode in pH 7 NIST buffer was tested by determining the time at which the deviation of pH measurement (measurement frequency: 1 s) from one point to the next is less than 0.1 mV. The observed swelling time was 30 min.

### Examples 2 to 3

| | | | | Crystal |
|---|---|---|---|---|
| | | | Swelling | or droplet |
| Example | Substance | Concentration | time (min) | formation |
| 2 | Pharmacoat 606 | 15% in 42.5% | 20 | No |
| | | EtOH and | | |
| | | 42.5% H₂O | | |
| 3 | Pharmacoat 606 | 10% in 40% | Not | No |
| | | EtOH and 50% | determined | |
| | | H₂O | | |

### Comparative Example

Multiple single-use pH combination electrodes were stored in a laboratory drying cabinet at 50° C. for 28 days. Crystal formation originating from the reference electrode liquid was observed.

### REFERENCE SIGNS

1 Ion-selective electrode
2 Reference electrode
3 Measurement electrode space containing internal electrolyte of the ion-selective electrode
4 Reference electrode space containing reference electrode electrolyte
5 Conducting electrode of the ion-selective electrode
6 Reference electrode
7 Ion-selective membrane
8 Junction from reference electrode space to the measurement space—here, an open-junction opening
9 Detachable and/or dissolvable protective coating
10 Sidewall of the single-use bioreactor
11 Weld seam or adhesive seam

1. A potentiometric electrode assembly comprising an ion-selective electrode, a reference electrode and a reference electrode electrolyte, the reference electrode having a diaphragm or an open-junction opening or a combination thereof, at least the diaphragm or the open-junction opening being provided with a protective coating detachable and/or dissolvable upon contact with an aqueous solution.

2. The potentiometric electrode assembly as claimed in claim 1, wherein the ion-selective electrode is an H⁺-selective glass electrode, the reference electrode is an Ag/AgCl reference electrode, and the reference electrode electrolyte is an aqueous alkali metal halide.

3. The potentiometric electrode assembly as claimed in claim 1, wherein the ion-selective electrode is intended for single use, is integrally fitted in a container, and container and electrode assembly have been sterilized after fitting of the electrode assembly.

4. The potentiometric electrode assembly as claimed in claim 1, wherein the detachable and/or dissolvable protective coating is a material authorized for pharmaceutical manufacturing processes.

5. The potentiometric electrode assembly as claimed in claim 1, wherein the detachable and/or dissolvable protective coating does not inhibit cell growth.

6. The potentiometric electrode assembly as claimed in claim 1, wherein the material of the detachable and/or dissolvable protective coating is selected from:
substances and/or nutrients usually present in a culture liquid;
polymers degradable in aqueous solution
excipients for medicaments.

7. The potentiometric electrode assembly as claimed in claim 6, wherein the material of the detachable and/or dissolvable protective coating is selected from: sugars, sugar alcohols, soluble starch, polyvinyl alcohol, microcrystalline cellulose and/or mixtures thereof.

8. A method for treating a potentiometric electrode assembly as claimed in any of the preceding claims, wherein
a detachable and/or dissolvable protective coating is applied to the diaphragm or the open-junction opening,
the protective coating thus obtained is left to dry or dried,
the electrode assembly is integrally fitted in a container and
the container containing the electrode assembly is sterilized.

9. A bioreactor equipped with a potentiometric electrode assembly as claimed in claim 1.

10. The bioreactor as claimed in claim 9, wherein the ion-selective electrode is precalibrated.

11. The bioreactor as claimed in claim 9, wherein the material to be measured is an aqueous cell culture solution.

12. A bioreactor equipped with a potentiometric electrode assembly obtained as claimed in claim 8
